(19) United States
(12) Patent Application Publication
(10) Pub. No.: US 2007/0043889 A1
(43) Pub. Date: Feb. 22, 2007

(54) Information processing apparatus and access method

(75) Inventors: Toshitaka Sanada, Ome-shi (JP); Toru Hanada, Ome-shi (JP); Terunobu Hara, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/500,194

(22) Filed: Aug. 7, 2006

(30) Foreign Application Priority Data
Aug. 19, 2005 (JP) 2005-238926

(51) Int. Cl. G06F 13/38

(52) U.S. Cl. 710/62

(57) ABSTRACT

According to one embodiment, an information processing apparatus includes a connection port to which an external storage device is detachably connectable, a determination unit which determines whether a format type of a memory medium, which is built in the external storage device connected to the connection port, is a first format type corresponding to a hard disk image or a second format type corresponding to a flexible disk image, and a drive number assignment unit which assigns a first drive number, which designates a hard disk drive, to the external storage device in a case where the format type of the memory medium is the first format type, and assigns a second drive number, which designates a flexible disk drive, to the external storage device in a case where the format type of the memory medium is the second format type.

### CROSS-REFERENCE TO RELATED APPLICATIONS

This application is based upon and claims the benefit of priority from Japanese Patent Application No. 2005-238926, filed Aug. 19, 2005, the entire contents of which are incorporated herein by reference.

### BACKGROUND

1. Field

One embodiment of the invention relates to an information processing apparatus such as a personal computer, and more particularly to an information processing apparatus having a connection port which is detachably connectable to an external storage device, and an access method for use in the apparatus.

2. Description of the Related Art

In recent years, various types of portable personal computers, such as laptop or notebook computers, have been developed. This type of computer has connection ports, such as a universal serial bus (USB) interface and an IEEE1394 interface, for extending the functions of the computer. Various external storage devices can be connected to such connection ports.

In usual cases, however, the external storage device, which is connected to the connection port, is handled as a removable medium. Thus, the external storage device cannot be handled as a bootable disk drive such as a hard disk drive (HDD) or a flexible disk drive (FDD). The use of the external storage device is relatively limited.

Jpn. Pat. Appln. KOKAI Publication No. 2004-151785 discloses a USB storage device which incorporates a flash memory. Upon receiving an inquiry from a host computer, the USB storage device returns to the host computer a response indicating that the USB storage device is a CD-ROM drive or a flexible disk drive. Thereby, the USB storage device is recognized by the host computer as a CD-ROM drive or a flexible disk drive in a pseudo-fashion.

However, if the external storage device is equipped with such a dedicated function for causing itself to be recognized as a CD-ROM drive or a flexible disk drive in a pseudo-fashion, the manufacturing cost of the external storage device would increase. On the other hand, if an ordinary external storage device which is not equipped with such a dedicated function cannot be handled as a CD-ROM drive or a flexible disk drive.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the external appearance of an information processing apparatus, as viewed from the front side, according to an embodiment of the present invention;

FIG. 2 is an exemplary perspective view showing the external appearance of the information processing apparatus shown in FIG. 1, as viewed from the rear side;

FIG. 3 is an exemplary perspective view showing an example of an external storage device which is connectable to the information processing apparatus shown in FIG. 1;

FIG. 4 is an exemplary block diagram showing the system configuration of the information processing apparatus shown in FIG. 1;

FIG. 5 is an exemplary block diagram illustrating the functional configuration of a system BIOS which is used in the information processing apparatus shown in FIG. 1;

FIG. 6 is an exemplary view showing a structure of a disk driver routine in the system BIOS which is used in the information processing apparatus shown in FIG. 1;

FIG. 7 is an exemplary view for explaining an example of a drive number table which is used in the information processing apparatus shown in FIG. 1;

FIG. 8 is an exemplary flow chart for explaining the operation of the disk driver routine shown in FIG. 6;

FIG. 9 is an exemplary view showing an example of a system setup screen which is used in the information processing apparatus shown in FIG. 1; and

FIG. 10 is an exemplary flow chart illustrating the procedure of a process which is executed when the information processing apparatus shown in FIG. 1 is powered on.

### DETAILED DESCRIPTION

Various embodiments according to the invention will be described hereinafter with reference to the accompanying drawings. In general, according to one embodiment of the invention, an information processing apparatus includes a main body, a connection port which is provided in the main body and to which an external storage device is detachably connectable, a determination unit which determines, in response to power-on of the main body, whether a format type of a memory medium, which is built in the external storage device connected to the connection port, is a first format type corresponding to a hard disk image or a second format type corresponding to a flexible disk image, and a drive number assignment unit which assigns a first drive number, which designates a hard disk drive, to the external storage device in a case where the format type of the memory medium is the first format type, and assigns a second drive number, which designates a flexible disk drive, to the external storage device in a case where the format type of the memory medium is the second format type.

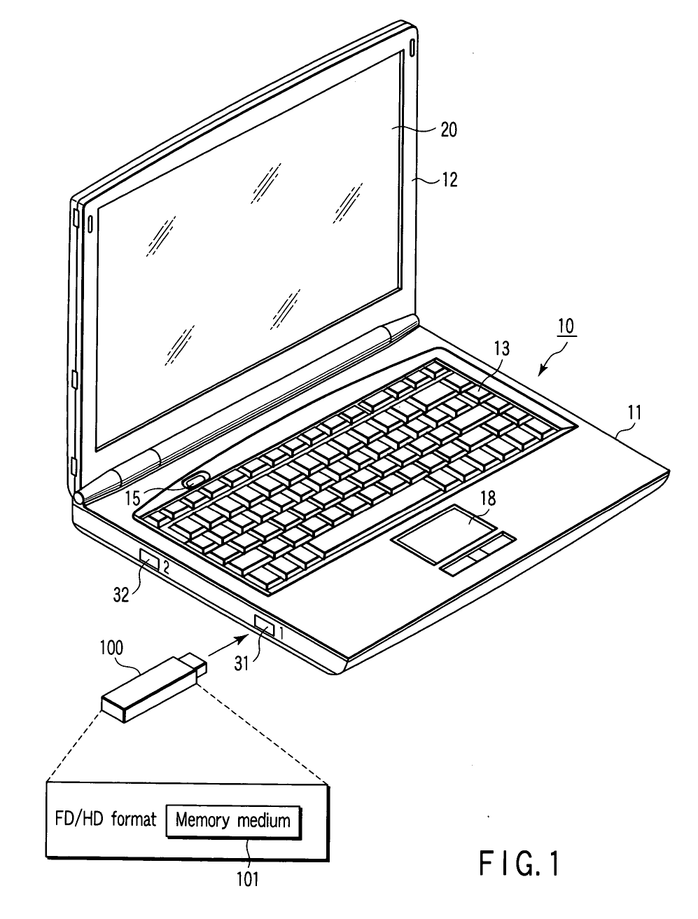

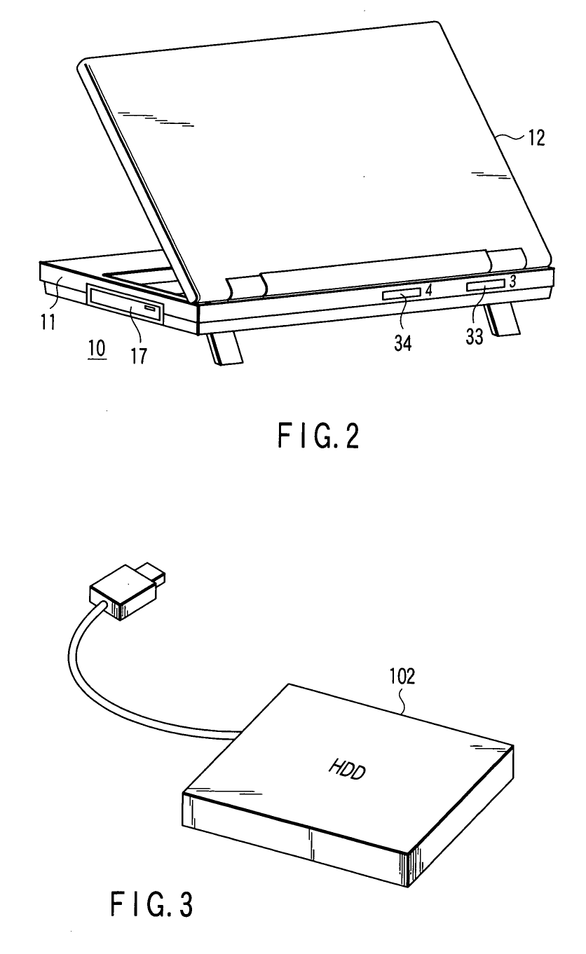

To begin with, the structure of an information processing apparatus according to an embodiment of the invention is described referring to FIG. 1 and FIG. 2. The information processing apparatus is realized, for example, as a battery-powerable portable notebook personal computer 10.

FIG. 1 is a perspective view showing the computer 10, as viewed from the front side, in the state in which a display unit is opened. FIG. 2 is a perspective view showing the computer 10, as viewed from the rear side.

The computer 10 comprises a computer main body 11 and a display unit 12. A display device that is composed of an LCD (Liquid Crystal Display) 20 is built in the display unit 12. The display screen of the LCD 20 is positioned at an approximately central part of the display unit 12.

The display unit 12 is supported on the computer main body 11 such that the display unit 12 is freely rotatable between an open position where the top surface of the computer main body 11 is exposed and a closed position where the top surface of the computer main body 11 is covered. The computer main body 11 has a thin box-shaped casing. A keyboard 13, a power button switch 15 for powering on/off the computer 10, and a touch pad 18 are disposed on the top surface of the computer main body 11. As shown in FIG. 2, an optical disc drive 17, such as a CD/DVD drive, is accommodated in the computer main body 11.

As shown in FIG. 1, two connection ports 31 and 32, to which an external storage device is detachably connectable, are provided on a left side surface of the computer main body 11. In addition, as shown in FIG. 2, two connection ports 33 and 34, to which an external storage device is detachably connectable, are provided on a rear side surface of the computer main body 11.

Each of the connection ports 31, 32, 33 and 34 is composed of a connector that supports, e.g. the Universal Serial Bus (USB) standard or the IEEE1394 standard. An external storage device 100, which supports the USB standard or IEEE1394 standard, can be connected, as needed, to each of the connection ports 31, 32, 33 and 34.

In the description below, it is assumed that each of the connection ports 31, 32, 33 and 34 is composed of a connector that supports the USB standard. Hereinafter, the connection ports 31, 32, 33 and 34 are referred to as USB ports 31, 32, 33 and 34.

Port numbers #1, #2, #3 and #4 are assigned to the USB ports 31, 32, 33 and 34. On the left side surface of the computer main body 11, numerals “1” and “2”, which are identification information indicative of the port numbers of the USB ports 31 and 32, are marked on peripheral areas of the USB ports 31 and 32. Similarly, on the rear side surface of the computer main body 11, numerals “3” and “4”, which are identification information indicative of the port numbers of the USB ports 33 and 34, are marked on peripheral areas of the USB ports 33 and 34. Viewing these numerals, the user can confirm which port numbers are assigned to which USB ports.

The external storage device 100 is composed of a storage device (USB storage device) with a USB-standard interface, such as a USB memory. The external storage device 100 incorporates a memory medium 101. The memory medium 101 is composed of a nonvolatile semiconductor memory such as a flash EEPROM.

The memory medium 101 is preformatted in a first format type corresponding to a hard disk (HD) image or in a second format type corresponding to a flexible disk (FD) image.

The first format type is a so-called “HD emulation format type” for handling the external storage device 100 as a virtual hard disk drive (HD-emulated drive). The second format type is a so-called “FD emulation format type” for handling the external storage device 100 as a virtual flexible disk drive (FD-emulated drive).

An external storage device 102, as shown in FIG. 3, can also be connected to the USB port and used. The external storage device 102 is a storage device having a USB-standard interface and accommodating a hard disk drive as a memory medium.

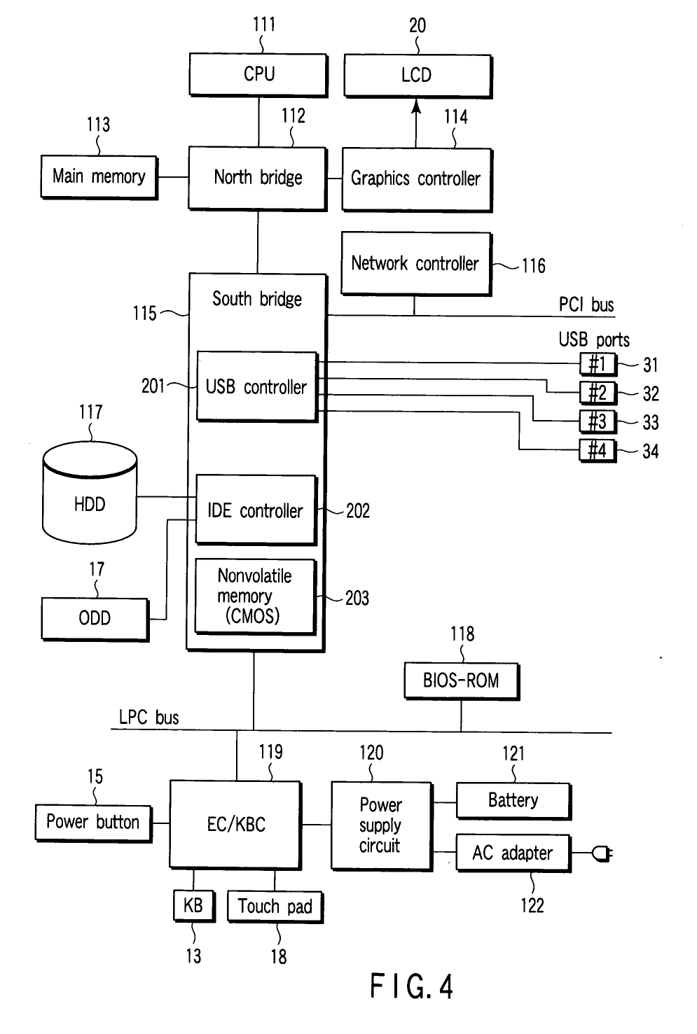

Next, referring to FIG. 4, an example of the system configuration of the computer 10 is described.

The computer 10 comprises a CPU 111, a north bridge 112, a main memory 113, a graphics controller 114, a south bridge 115, a network controller 116, a built-in hard disk drive (HDD) 117, a flash BIOS-ROM 118, an embedded controller/keyboard controller IC (EC/KBC) 119, and a power supply circuit 120.

The CPU 111 is a processor that controls the operation of the components of the computer 10. The CPU 111 executes an operating system and various application programs, which are loaded from the built-in HDD 117 or an external storage device into the main memory 113. The CPU 111 also executes a system BIOS (Basic Input/Output System) that is stored in the flash BIOS-ROM 118. The system BIOS is a program for hardware control. Responding to power-on of the computer 10, the system BIOS executes a POST (Power-On Self Test) process. In the POST process, the system BIOS executes operation tests and initializing processes for the respective components of the computer 10.

Further, in the POST process, the system BIOS determines, on a USB port by USB port basis, the format type of the memory medium which is built in the external storage device that is connected to the USB port.

If the format type of the memory medium, which is built in a certain external storage device, is a first format type (HD emulation format type), the system BIOS assigns a first drive number (8xh) to the external storage device in order to handle the external storage device as a hard disk drive. The first drive number (8xh) is a drive number for designating the hard disk drive. In this manner, by assigning the first drive number (8xh), which is to be assigned to the hard disk drive, to the external storage device such as a USB memory, the external storage device can be handled as a virtual hard disk drive.

The value of the first drive number varies from hard disk drive to hard disk drive. If there are two hard disk drives, a drive number (80h) is assigned to the first hard disk drive and a drive number (81h) is assigned to the second hard disk drive.

If the format type of the memory medium, which is built in a certain external storage device, is a second format type (FD emulation format type), the system BIOS assigns a second drive number (0xh) to the external storage device in order to handle the external storage device as a flexible disk drive. The second drive number (0xh) is a drive number for designating the flexible disk drive. In this way, by assigning the second drive number (0xh), which is to be assigned to the flexible disk drive, to the external storage device such as a USB memory, the external storage device can be handled as a virtual flexible disk drive.

The value of the second drive number varies from flexible disk drive to flexible disk drive. If there are two flexible disk drives, a drive number (00h) is assigned to the first flexible disk drive and a drive number (01h) is assigned to the second flexible disk drive.

The north bridge 112 is a bridge device that connects a local bus of the CPU 111 and the south bridge 115. The north bridge 112 has a function of executing communication with the graphics controller 114 via, e.g. an AGP (Accelerated Graphics Port) bus. The north bridge 112 includes a memory controller that controls the main memory 113.

The graphics controller 114 is a display controller for controlling the LCD 20 that is used as a display monitor of the computer 10. The south bridge 115 is connected to a PCI (Peripheral Component Interconnect) bus and an LPC (Low Pin Count) bus. In addition, the south bridge 115 includes a USB controller 201, an IDE (Integrated Drive Electronics) controller 202 and a nonvolatile memory 203. The USB controller 201 executes communication with external storage devices that are connected to the USB ports 31 to 34. The IDE controller 202 controls the built-in HDD 117 and the optical disc drive (ODD) 17.

The nonvolatile memory 203 is a memory which is called “CMOS memory”. The nonvolatile memory 203 is used for storing setup information that designates the operational environment of the computer 10. The setup information includes boot priority-order information, and mode designation information relating to external storage devices.

The embedded controller/keyboard controller IC (EC/KBC) 119 is a 1-chip microcomputer in which an embedded controller for power management and a keyboard controller for controlling the keyboard (KB) 13 and touch pad 18 are integrated. The embedded controller/keyboard controller IC 119 cooperates with the power supply circuit 120 to power on/off the computer 10 in response to the user's operation of the power button switch 15. The power supply circuit 120 generates system power, which is to be supplied to the components of the computer 10, using power from a battery 121 or external power supplied from an AC adapter 122.

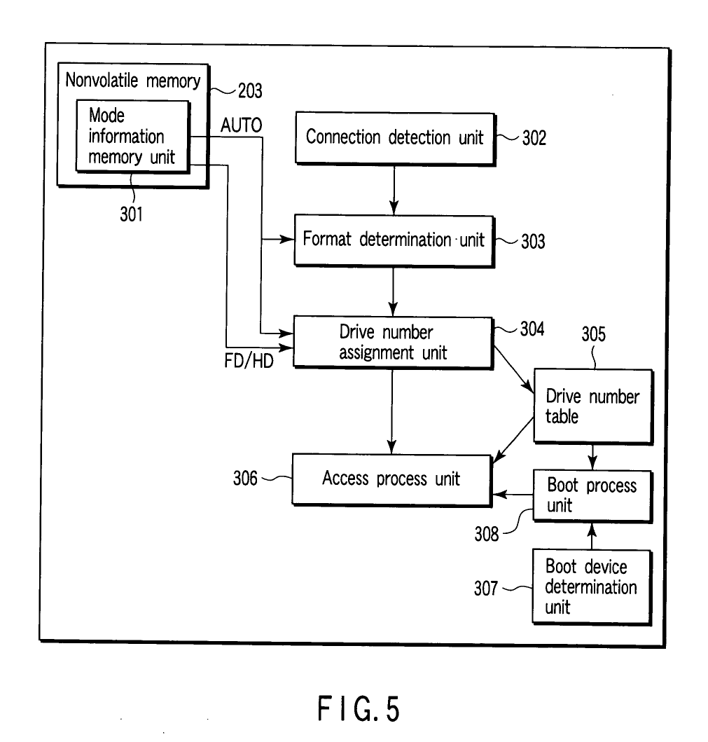

Next, referring to FIG. 5, the functional configuration for controlling the external storage device is described.

The control of the external storage device is executed by a connection detection unit 302, a format determination unit 303, a drive number assignment unit 304, a drive number table 305, an access process unit 306, a boot device determination unit 307 and a boot process unit 308. The connection detection unit 302, format determination unit 303, drive number assignment unit 304, access process unit 306, boot device determination unit 307 and boot process unit 308 are realized as function executing modules (software modules) within the system BIOS.

The connection detection unit 302 executes, with respect to each of the USB ports 31 to 34, a process for determining whether an external storage device is connected to the USB port. If the external storage device is connected to any one of the USB ports, the format determination unit 303 reads the content of the memory medium that is built in the external storage device, and determines whether the format type of the memory medium is the first format type (HD emulation format type) or second format type (FD emulation format type).

In accordance with the above-described mode designation information, the drive number assignment unit 304 executes the process for assigning the drive number to the external storage device. The mode designation information is stored in a mode information memory unit 301 within the nonvolatile memory 203. The mode designation information is information which designates the mode that is to be used in order to control the external storage device. The mode designation information designates one of a first mode (HD mode), a second mode (FD mode) and a third mode (Auto mode).

The first mode (HD mode) is a mode which designates handling of the external storage device as a hard disk drive. The second mode (FD mode) is a mode which designates handling of the external storage device as a flexible disk drive. The third mode (Auto mode) is a mode which automatically determines whether the external storage device is to be handled as a hard disk drive or a flexible disk drive, in accordance with the format type of the memory medium that is built in the external storage device.

The user is able to select one of the first mode (HD mode), second mode (FD mode) and third mode (Auto mode), using a BIOS setup function or a dedicated utility program.

The format determination process by the format determination unit 303 is executed when the mode designation information indicates the third mode (Auto mode), and is not executed when the mode designation information indicates the first mode (HD mode) or second mode (FD mode).

In the case where the mode designation information indicates the first mode (HD mode), the drive number assignment unit 304 assigns the first drive number (8xh) to the external storage device, regardless of the format type of the external storage device. On the other hand, in the case where the mode designation information indicates the second mode (FD mode), the drive number assignment unit 304 assigns the second drive number (0xh) to the external storage device, regardless of the format type of the external storage device.

Consequently, if the external storage device which is formatted in the second format type (FD emulation format type) is connected, despite the mode designation information selected by the user indicating the first mode (HD mode), the external storage device cannot normally be handled as a hard disk drive or a flexible disk drive. Similarly, if the external storage device which is formatted in the first format type (HD emulation format type) is connected, despite the mode designation information selected by the user indicating the second mode (FD mode), the external storage device cannot normally be handled as a hard disk drive or a flexible disk drive.

In this case, the user is required to perform an operation of rebooting the computer 10 after altering the mode designation information using the BIOS setup function or dedicated utility program.

In the case where the mode designation information indicates the third mode (Auto mode), the drive number assignment unit 304 automatically assigns, on the basis of the format type determination result obtained by the format determination unit 303, the first drive number (8xh) designating the hard disk drive or the second drive number (0xh) designating the flexible disk drive to the external storage device. Specifically, if the format type of the memory medium built in the external storage device is the first format type (HD emulation format type), the drive number assignment unit 304 assigns the first drive number (8xh), which designates the hard disk drive, to the external storage device. In addition, if the format type of the memory medium built in the external storage device is the second format type (FD emulation format type), the drive number assignment unit 304 assigns the second drive number (0xh), which designates the flexible disk drive, to the external storage device.

In the third mode (Auto mode), as described above, the proper drive number (8xh or 0xh) corresponding to the format type of the memory medium built in the external storage device is automatically assigned to the external storage device. Thus, whether the format type of the external storage device is the HD emulation format type or FD emulation format type, the external storage device can normally be handled as the hard disk drive or flexible disk drive.

The drive number assignment unit 304 stores information, which indicates the relationship between the external storage device and the drive number assigned to the external storage device, in the drive number table 305.

Referring to the drive number table 305, the access process unit 306 recognizes which drive number is assigned to the external storage device. In the case where the first drive number (8xh) is assigned to the external storage device, the access process unit 306 accesses the external storage device in response to a disk access request designating the first drive number (8xh), which is sent from software (e.g. installer, operating system, other routines in the system BIOS, etc.). On the other hand, in the case where the second drive number (0xh) is assigned to the external storage device, the access process unit 306 accesses the external storage device in response to a disk access request designating the second drive number (0xh), which is sent from the software.

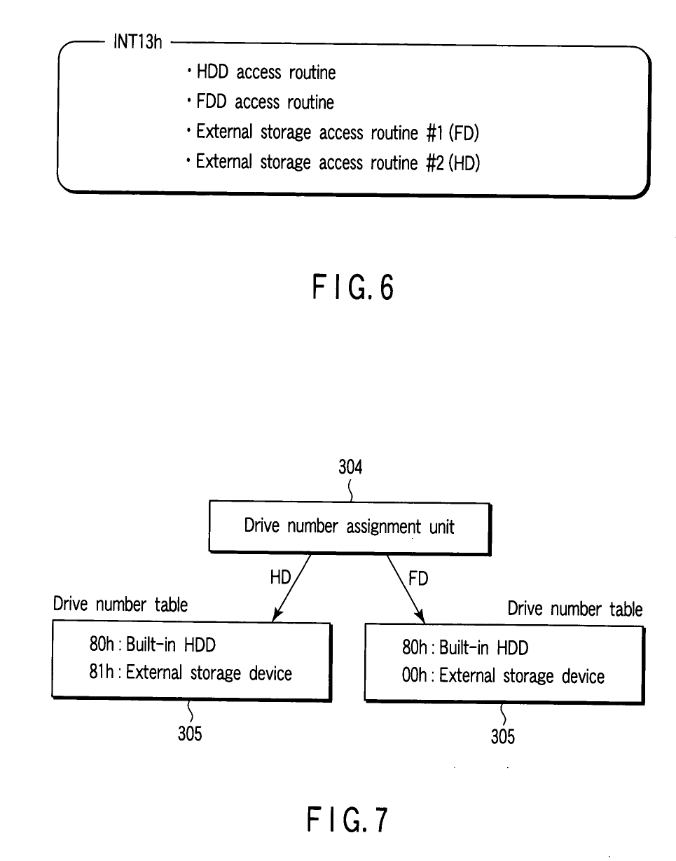

The access process unit 306 is realized by a disk driver routine in the system BIOS. The disk driver routine is a program that is executed by a software interrupt (INT13h). The disk driver routine, as shown in FIG. 6, includes an HDD access routine for accessing a hard disk drive (HDD), an FDD routine for accessing a flexible disk drive (FDD), and two external storage access routines. One of the external storage access routines, #1, is a routine for accessing the external storage device of the second format type (FD emulation format type) via the USB controller 201 in response to a disk access request for the flexible disk drive. The other external storage access routine #2 is a routine for accessing the external storage device of the first format type (HD emulation format type) via the USB controller 201 in response to a disk access request for the hard disk drive.

In the case where the second drive number (0xh) is assigned to the external storage device, the access process unit 306 executes the external storage access routine #1 when the access process unit 306 receives from the software a disk access request including the second drive number (0xh) as an argument. The external storage access routine #1 executes emulation from the procedure for accessing the flexible disk drive, which is executed by the software, to the procedure for accessing the external storage device. Hence, the external storage device can be handled like the flexible disk drive simply by executing the ordinary process for accessing the flexible disk drive.

On the other hand, in the case where the first drive number (8xh) is assigned to the external storage device, the access process unit 306 executes the external storage access routine #2 when the access process unit 306 receives from the software a disk access request including the first drive-number (8xh) as an argument. The external storage access routine #2 executes emulation from the procedure for accessing the hard disk drive, which is executed by the software, to the procedure for accessing the external storage device. Hence, the external storage device can be handled like the hard disk drive simply by executing the ordinary process for accessing the hard disk drive.

The boot device determination unit 307 determines whether the external storage device is a boot device or not, on the basis of the above-described boot priority-order information and the drive number that is assigned to the external storage device. In the case where the external storage device is determined as the boot device, the boot process unit 308 executes a process for booting up the computer 10 from the external storage device. In the boot-up process, the boot process unit 308 issues a disk access request to the access process unit 306. This disk access request includes as an argument the drive number that is assigned to the external storage device. Thereby, the system program, such as the operating system, which is stored in the external storage device, is loaded in the main memory 113 and is executed.

FIG. 7 shows an example of the drive number table 305.

As described above, if the external storage device is formatted in the first format type (HD emulation format type), the first drive number (8xh) is assigned to the external storage device.

In this case, the drive number assignment unit 304 assigns, on the basis of HDD priority-order information indicative of the priority-order relationship between the built-in hard disk drive 117 and external storage device, a disk drive number (80h), which designates the first hard disk drive, to one of the built-in hard disk drive 117 and external storage device, and a disk drive number (81h), which designates the second hard disk drive, to the other of the built-in hard disk drive 117 and external storage device.

If the external storage device is formatted in the second format type (FD emulation format type), the second drive number (0xh) is assigned to the external storage device. If an FDD is not built in the computer 10, a disk drive number (00h), which designates the first flexible disk drive, is assigned to the external storage device.

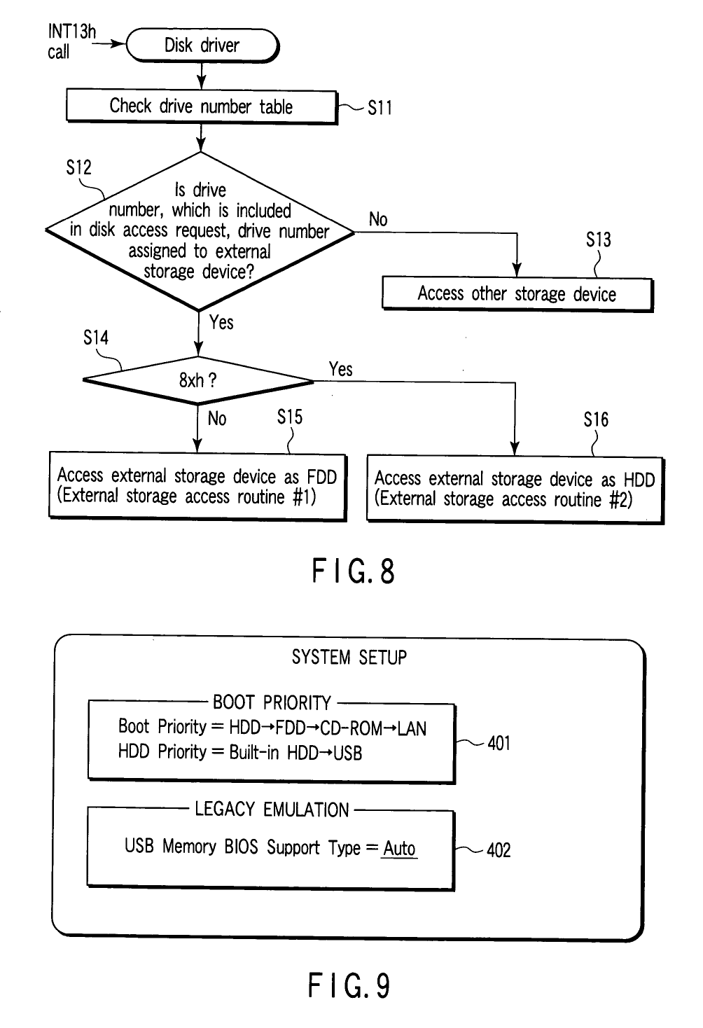

Next, with reference to a flow chart of FIG. 8, the operation of the access process unit (disk driver) 306 is described.

When the disk driver is called by software, the access process unit 306 checks the drive number table 305 (block S11) and determines whether the drive number, which is included in the disk access request from the software, is a drive number which is assigned to the external storage device (block S12).

If the drive number, which is included in the disk access request from the software, is not the number assigned to the external storage device (NO in block S12), the access process unit 306 accesses a device, such as the built-in HDD/FDD, other than the external storage device, by the HDD access routine or FDD access routine (block S13).

If the drive number, which is included in the disk access request from the software, is the drive number assigned to the external storage device (YES in block S12), the access process unit 306 determines whether the drive number included in the disk access request is the first drive number (8xh) or not (block S14).

If the drive number included in the disk access request is not the first drive number (8xh), that is, if the drive number included in the disk access request is the second drive number (0xh) (NO in block S14), the access process unit 306 executes the external storage access routine #1 and accesses the external storage device to which the second drive number (0xh) is assigned (block S15).

If the drive number included in the disk access request is the first drive number (8xh) (YES in block S14), the access process unit 306 executes the external storage access routine #2 and accesses the external storage device to which the first drive number (8xh) is assigned (block S16).

FIG. 9 shows an example of a system setup screen which is displayed on the LCD 20 by the system BIOS.

The system setup screen includes, as a setup menu, a “BOOT PRIORITY” field 401 and a “LEGACY EMULATION” field 402. The “BOOT PRIORITY” field 401 includes a “Boot Priority” item for setting boot priority-order information, and an “HDD Priority” item for setting HDD priority-order information.

The boot priority-order information is information which designates the order of use of disk drives for system boot-up. A standard value of the boot priority-order information is, for example,

HDD→FDD→CD-ROM→LAN.

The user may move the cursor to the “Boot Priority” item and press the space key, thus being able to alter the boot priority-order information. In the boot priority-order information, “HDD” represents a built-in HDD or an external storage device (e.g. USB memory) to which the first drive number (8xh) is assigned, and “FDD” represents an FDD or an external storage device (e.g. USB memory) to which the second drive number (0xh) is assigned.

The HDD priority-order information is information which designates a priority order between the built-in HDD and the external storage device (e.g. USB memory). A standard value of the HDD priority-order information is, for example,

Built-in HDD→External storage device (USB memory).

The user may move the cursor to the “HDD Priority” item and press the space key, thus being able to alter the HDD priority-order information to

External storage device (USB memory)→Built-in HDD.

The “LEGACY EMULATION” field 402 includes an item “USB Memory BIOS Support Type” for setting the above-described mode designation information. The user may move the cursor to the “USB Memory BIOS Support Type” and press the space key, thus being able to select “HD mode”, ”FD mode” or “Auto mode”.

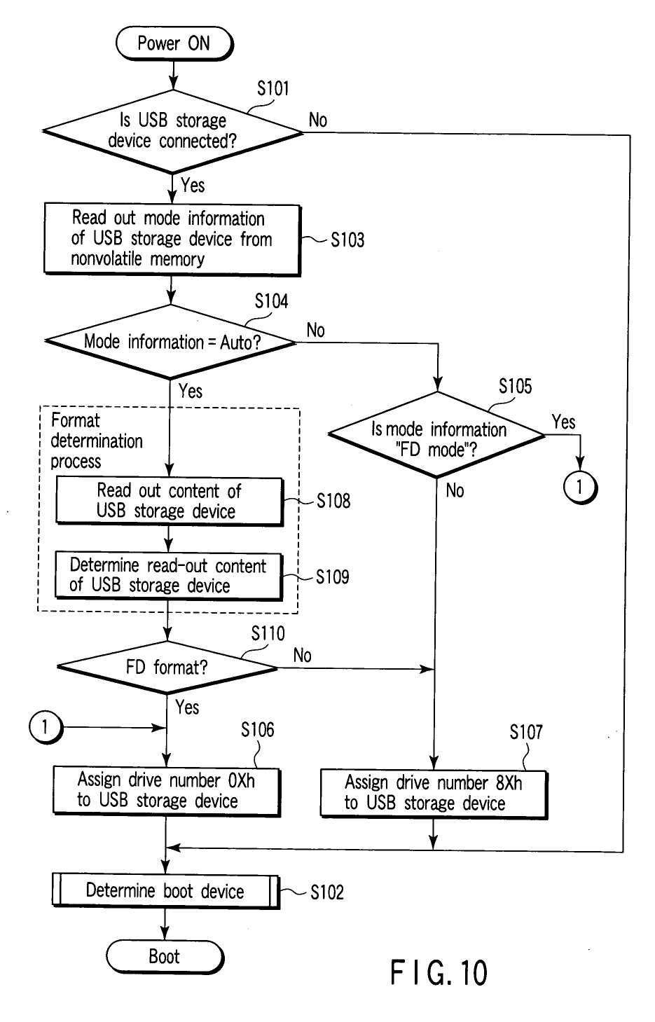

Next, referring to a flow chart of FIG. 10, a description is given of the procedure of a process which is executed by the system BIOS when the computer 10 is powered on.

When the computer main body 11 is powered on, the CPU 111 executes the system BIOS, thereby performing the following process.

To start with, the CPU 111 determines, with respect to each of the USB ports, whether an external storage device (e.g. a USB storage device such as a USB memory) is connected to the USB port (block S101). If the external storage device is connected to none of the USB ports (NO in block S101), the CPU 111 determines the boot device on the basis of the boot priority-order information (block S102). Then, the CPU 111 executes the process for booting up the computer 10 from the determined boot device. Thereby, a process for booting up a system program, such as the operating system, or a process for installing the operating system is executed.

If the external storage device is connected to any one of the USB ports (YES in block S101), the CPU 111 reads out mode designation information that is stored in the nonvolatile memory 203, and determines whether the current mode which is designated by the mode designation information is the Auto mode or not (block S104).

If the current mode which is designated by the mode designation information is the Auto mode, the CPU 111 executes the format determination process for determining the format type of the memory medium built in the external storage device (block S108, S109). In the format determination process, the CPU 111 read-accesses the memory medium built in the external storage device and reads out content of the memory medium, e.g. a first sector (block S108). Based on the read-out content (e.g. first sector), the CPU 111 determines whether the format type of the memory medium is the first format type (HD emulation format type) or second format type (FD emulation format type) (block S109). If the format type of the memory medium is the first format type (HD emulation format type), a master boot record is present in the data of the first sector. On the other hand, if the format type of the memory medium is the second format type (FD emulation format type), a master boot record is not present. Thus, the CPU 111 determines the first format type (HD emulation format type) if the master boot record is present in the memory medium, and determines the second format type (FD emulation format type) if the master boot record is not present.

If the format type of the memory medium is the second format type (FD emulation format type) (YES in block S110), the CPU 111 assigns to the external storage device the drive number 0xh for handling the external storage device as a flexible disk drive (block S106). Thereby, the external storage device is accessed as a flexible disk drive from the software. On the other hand, if the format type of the memory medium is the first format type (HD emulation format type) (NO in block S110), the CPU 111 assigns to the external storage device the drive number 8xh for handling the external storage device as a hard disk drive (block S107). Thereby, the external storage device is accessed as a hard disk drive from the software.

In block S107, the CPU 111 determines, on the basis of the HDD priority-order information, whether the external storage device has a higher priority than the built-in HDD. If the external storage device has a higher priority than the built-in HDD, the CPU 111 assigns the disk drive number 80h, which designates the first hard disk drive, to the external storage device, and assigns the disk drive number 81h, which designates the second hard disk drive, to the built-in HDD. On the other hand, if the built-in HDD has a higher priority than the external storage device, the CPU 111 assigns the disk drive number 80h, which designates the first hard disk drive, to the built-in HDD, and assigns the disk drive number 81h, which designates the second hard disk drive, to the external storage device.

If the current mode which is designated by the mode designation information is not the Auto mode, the CPU 111 determines whether the current mode is the FD mode or HD mode (block S105). If the current mode is the FD mode, the CPU 111 assigns to the external storage device the drive number 0xh for handling the external storage device as a flexible disk drive (block S106). If the current mode is the HD mode, the CPU 111 assigns to the external storage device the drive number 8xh for handling the external storage device as a hard disk drive (block S107).

Subsequently, the CPU 111 executes the process for determining the boot device (block S102). In block S102, the CPU 111 determines whether the external storage device is the boot device or not, on the basis of the above-described boot priority-order information and the drive number (8xh or 0xh) that is assigned to the external storage device. For example, if the drive number of the external storage device is 00h and the FDD is designated as a device with a high priority by the boot priority-order information, the external storage device is determined as the boot device and the process for booting up the computer 10 is executed from the external storage device. If the drive number of the external storage device is 80h and the HDD is designated as a device with a high priority by the boot priority-order information, the external storage device is determined as the boot device and the process for booting up the computer 10 is executed from the external storage device.

As has been described above, in the present embodiment, when the Auto mode is selected, the system BIOS automatically assigns the proper drive number to the external storage device in accordance with the format type of the external storage device. Thereby, the user is enabled to normally handle the external storage device as a hard disk drive or a flexible disk drive, without explicitly designating which of the HD emulation format type or the FD emulation format type is to be used. Furthermore, the user can easily boot up the operating system from the external storage device such as the USB memory, or install the operating system from, e.g. the ODD 17 into the USB memory.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main body;
a connection port which is provided in the main body and to which an external storage device is detachably connectable;
a determination unit which determines, in response to power-on of the main body, whether a format type of a memory medium, which is built in the external storage device connected to the connection port, is a first format type corresponding to a hard disk image or a second format type corresponding to a flexible disk image; and
a drive number assignment unit which assigns a first drive number, which designates a hard disk drive, to the external storage device in a case where the format type of the memory medium is the first format type, and assigns a second drive number, which designates a flexible disk drive, to the external storage device in a case where the format type of the memory medium is the second format type.

2. The information processing apparatus according to claim 1, further comprising an access process unit which accesses, in a case where the first drive number is assigned to the external storage device, the external storage device in response to a disk access request designating the first drive number, and accesses, in a case where the second drive number is assigned to the external storage device, the external storage device in response to a disk access request designating the second drive number.

3. The information processing apparatus according to claim 1, further comprising:
a boot device determination unit which determines whether the external storage device is a boot device based on boot priority-order information and the drive number which is assigned to the external storage device; and
a boot process unit which executes a process of booting up the information processing apparatus from the external device in a case where the external storage device is determined as the boot device.

4. The information processing apparatus according to claim 1, further comprising a nonvolatile memory which stores mode designation information designating one of a first mode which designates handling of the external storage device as the hard disk drive, a second mode which designates handling of the external storage device as the flexible disk drive, and a third mode which determines whether the external storage device is to be handled as the hard disk drive or the flexible disk drive in accordance with the format type of the memory medium built in the external storage device,
wherein the drive number assignment unit assigns the first drive number to the external storage device in a case where the mode designation information designates the first mode, and assigns the second drive number to the external storage device in a case where the mode designation information designates the second mode.

5. The information processing apparatus according to claim 1, further comprising a built-in hard disk drive which is provided within the main body,
wherein in a case where the format type of the memory medium is the first format type, the drive number assignment unit assigns, based on information indicative of a priority-order relationship between the built-in hard disk drive and the external storage device, a disk drive number, which designates a first hard disk drive, to one of the built-in hard disk drive and the external storage device, and a disk drive number, which designates a second hard disk drive, to the other of the built-in hard disk drive and the external storage device.

6. The information processing apparatus according to claim 1, wherein the connection port is a connector which supports a Universal Serial Bus standard, and the external storage device is a device which has an interface supporting the Universal Serial Bus standard and incorporates a nonvolatile semiconductor memory as a memory medium.

7. The information processing apparatus according to claim 1, wherein the connection port is a connector which supports a Universal Serial Bus standard, and the external storage device is a device which has an interface supporting the Universal Serial Bus standard and incorporates a hard disk drive as a memory medium.

8. An access method for accessing an external storage device which is detachably attached to a connection port which is provided in an information processing apparatus, the access method comprising:
determining, in response to power-on of the information processing apparatus, whether a format type of a memory medium, which is built in the external storage device connected to the connection port, is a first format type corresponding to a hard disk image or a second format type corresponding to a flexible disk image;
assigning a first drive number, which designates a hard disk drive, to the external storage device in a case where the format type of the memory medium is the first format type; and
assigning a second drive number, which designates a flexible disk drive, to the external storage device in a case where the format type of the memory medium is the second format type.

9. The access method according to claim 8, further comprising accessing, in a case where the first drive number is assigned to the external storage device, the external storage device in response to a disk access request designating the first drive number; and
accessing, in a case where the second drive number is assigned to the external storage device, the external storage device in response to a disk access request designating the second drive number.

10. The access method according to claim 8, further comprising:
determining whether the external storage device is a boot device based on boot priority-order information and the drive number which is assigned to the external storage device; and
executing a process of booting up the information processing apparatus from the external device in a case where the external storage device is determined as the boot device.

11. The access method according to claim 8, wherein the information processing apparatus includes a nonvolatile memory which stores mode designation information designating one of a first mode which designates handling of the external storage device as the hard disk drive, a second mode which designates handling of the external storage device as the flexible disk drive, and a third mode which determines whether the external storage device is to be handled as the hard disk drive or the flexible disk drive in accordance with the format type of the memory medium built in the external storage device, and
the access method further comprises:
assigning the first drive number to the external storage device in a case where the mode designation information designates the first mode; and
assigning the second drive number to the external storage device in a case where the mode designation information designates the second mode.

12. The access method according to claim 8, wherein the information processing apparatus includes a built-in hard disk drive, and
said assigning the first drive number to the external storage device includes assigning, based on information indicative of a priority-order relationship between the built-in hard disk drive and the external storage device, a disk drive number, which designates a first hard disk drive, to one of the built-in hard disk drive and the external storage device, and a disk drive number, which designates a second hard disk drive, to the other of the built-in hard disk drive and the external storage device.
